(19) United States
(12) Patent Application Publication
(10) Pub. No.: US 2026/0346408 A1
(43) Pub. Date: Nov. 5, 2026

(54) Tool Head

(71) Applicant: Bosch Power Tools (China) Co., Ltd., Zhejiang (CN)

(72) Inventor: Yongpu Yan, Zhejiang (CN)

(21) Appl. No.: 19/486,935

(22) PCT Filed: May 17, 2024
(86) PCT No.: PCT/CN2024/093838

§ 371 Date: Nov. 23, 2025

(30) Foreign Application Priority Data
May 26, 2023 (CN) 2023 2131 3309.7

(51) Int. Cl. B25B 15/00; B25B 21/00; B25B 23/00

(52) U.S. Cl. CPC B25B 15/001; B25B 21/007; B25B 23/0035

(57) ABSTRACT

A tool head defines a central axis extending along a longitudinal direction and includes a drive portion adapted to engage a driver, a head portion adapted to engage a fastener, and an intermediate portion connecting the drive portion and the head portion. The drive portion is connected to the intermediate portion by a first transition portion that tapers to extend from the drive portion in the longitudinal direction to the intermediate portion. The head portion is connected to the intermediate portion by a second transition portion that tapers to extend from the head portion in the longitudinal direction to the intermediate portion. The intermediate portion includes a tapered portion having a longitudinal length greater than 80% of the minimum length of the intermediate portion, and in a longitudinal section of the tool head passing through the central axis, both the first transition portion and the second transition portion have a concave curvature, and the tapered portion has a linear profile.

### TECHNICAL FIELD

The present application relates to a tool head, in particular a tool head for driving fasteners.

### BACKGROUND ART

In general, a tool head includes a drive portion, a head portion, and an intermediate portion that connects the drive portion and the head portion. The drive portion is used to engage a manual driver, a mechanical driver, or a motorized or pneumatically operated driver, and the head portion can be used to engage fasteners of different sizes or types, thereby enabling rotation of the fasteners, such as loosening or tightening the fasteners, with minimal force.

In particular, when the tool head is used with a driver operated electrically or pneumatically, the torque from the driver received by the tool head is impactful. The impactful torque is transmitted to the head portion through the intermediate portion in a form of elongated body, and the head portion drives the fastener to rotate while being subjected to the counteracted torqued of the fastener. At this time, the counteracted torque is correspondingly impactful, with a large instantaneous magnitude, which easily destroys the head portion of the tool head.

### SUMMARY OF THE INVENTION

An object of the present application is to reduce the counteracted torque from the fastener to the head portion when an impact torque is applied to the drive portion of the tool head.

To this end, the present application provides a tool head defining a central axis extending along a longitudinal direction and including a drive portion adapted to engage a driver, a head portion adapted to engage a fastener, and an intermediate portion connecting the drive portion and the head portion, wherein the drive portion is connected to the intermediate portion by a first transition portion that tapers to extend from the drive portion in the longitudinal direction to the intermediate portion, the head portion is connected to the intermediate portion by a second transition portion that tapers to extend from the head portion in the longitudinal direction to the intermediate portion, the intermediate portion includes a tapered portion having a longitudinal length greater than 80% of the minimum length of the intermediate portion, and in a longitudinal section of the tool head passing through the central axis, both the first transition portion and the second transition portion have a concave curvature, and the tapered portion has a linear profile.

In an embodiment, the intermediate portion includes only one tapered portion that tapers to extend from one of the first transition portion and the second transition portion to the other.

In an embodiment, the tapered portion includes one or more tapered portions tapering in a direction from the first transition portion towards the second transition portion; and/or one or more
tapered portions tapering in a direction from the second transition portion towards the first transition portion. In an embodiment, the intermediate portion further includes a cylindrical portion.

In an embodiment, the taper of the tapered portion is 1 degree to 4 degrees, the minimum outer diameter of the intermediate portion is 0.9 mm to 6.1 mm, and the minimum length of the intermediate portion is 2 mm.

In an embodiment, the drive portion includes a first drive segment and a second drive segment spaced by a groove extending in a circumferential direction about the central axis.

In an embodiment, the head portion has a convex polygonal structure, or the head portion includes two, three, four, five, six or more convex ribs evenly spaced in a circumferential direction around the central axis, adjacent convex ribs being spaced by a channel.

In an embodiment, the intermediate portion and the head portion are a first intermediate portion and a first head portion; the tool head further includes a second head portion adapted to engage a fastener and a second intermediate portion connecting the drive portion and the head portion, the first intermediate portion and the second intermediate portion respectively protruding from opposite sides of the drive portion in the longitudinal direction.

In an embodiment, the tapered portions that make up the first intermediate portion and the second intermediate portion taper to extend in opposite directions from the drive portion towards the first head portion and the second head portion, respectively, or the tapered portions that make up the first intermediate portion and the second intermediate portion taper to extend in the same direction from one of the first head portion and the second head portion towards the other of the first head portion and the second head portion.

In an embodiment, any one of the first head portion and the second head portion: includes a head tip adapted to engage a fastener, a head drive portion adapted to engage a driver, and a head groove spacing the head tip and the head drive portion in a longitudinal direction.

According to the present application, the tool head includes a drive portion for engaging a driver and a head portion for engaging a fastener and an intermediate portion located between the drive portion and the head portion, two ends of the intermediate portion being connected to the drive portion and the head portion through a first transition portion and a second transition portion, respectively. The drive portion includes at least one tapered portion extending in a direction from one of the drive portion and the head portion towards the other of the drive portion and the head portion, and the tapered portion extends over a majority or substantially the entire longitudinal length of the intermediate portion. The intermediate portion of the tool head of such a structure optimizes the absorption of torque, especially impact torque, applied to the drive portion of the tool head by a driver, to avoid the head portion of the tool head being subject to excessive counter-torque from the fasteners, which would result in head breakage.

### BRIEF DESCRIPTION OF THE DRAWINGS

FIG. 1 is a first embodiment of a tool head configured according to the present application.

FIG. 2 is a variant of the first embodiment of the tool head.

FIG. 3 is another variant of the first embodiment of the tool head.

FIG. 4 is yet another variant of the first embodiment of the tool head.

FIG. 5 is a second embodiment of the tool head configured according to the present application.

### DETAILED DESCRIPTION OF THE EMBODIMENTS

Certain embodiments of the tool head of the present application are described in detail below with reference to the accompanying drawings. Throughout the drawings, the same or corresponding portions are indicated with the same reference signs.

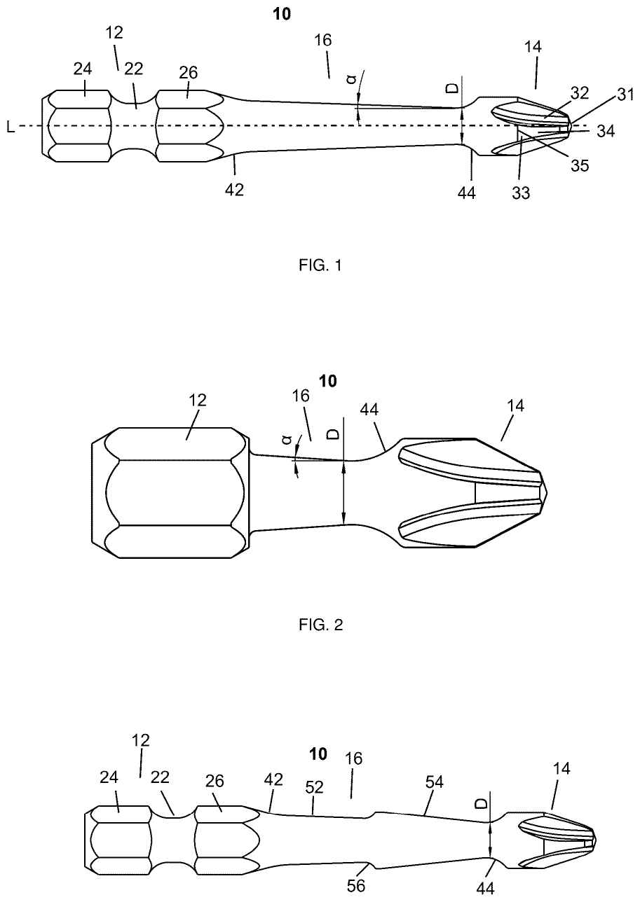

Referring to FIG. 1, a tool head 10 for operating fasteners is generally in the form of an elongated tool body including a drive portion 12 adapted to engage a driver, a head portion 14 adapted to engage a workpiece or a fastener, and an intermediate portion 16 to connect the drive portion 12 and the head portion 14. The tool head 10 defines a central axis extending along a longitudinal direction L. The longitudinal section is a plane that extends longitudinally through the central axis of the tool head 10 and the cross-section is a plane that passes through the tool head 10perpendicular to the central axis.

In the illustrated embodiment, the drive portion 12 may have a hexagonal shape to enable engagement with a common driver, and upon receiving torque from the driver, the tool head 10 rotates about a central axis, transmitting the torque to a fastener engaged with the head portion 14 of the tool head 10, causing it to rotate synchronously. The driver may be any possible tool, adapter, or other drive component in the art. For example, the driver may be a drive handle or drive sleeve suitable for manual operation by an operator; for example, the driver may be an electrically or pneumatically operated driver, such as a chuck of an electric tool; and, as another example, the driver may be a mechanical driver. For different drivers, the drive portion 12 may have other external shapes or configurations that differ from the hexagonal shape. In some embodiments, the driver may be an impact driver.

In the illustrated embodiment, the drive portion 12 of the tool head 10 includes two drive segments 24 and 26 spaced apart by a groove 22 extending in a circumferential direction perpendicular to the longitudinal direction L, the groove 22 being configured to receive a fast release structure such as a ball brake. In some embodiments, the tool head 10 may be free of

The head portion 14 includes a plurality of convex ribs 34 spaced about a central axis, adjacent convex ribs 34 being spaced through a channel 32. The channel 32 and the convex ribs 34 may be elongated straightly along the longitudinal direction L from a tip or end 31 of the head portion 14 to engage fasteners having corresponding straight slots; or alternatively, may be elongated curvedly relative to the longitudinal direction L as illustrated to accommodate fasteners having correspondingly shaped slots. In the illustrated exemplary embodiment, a radially outer surface 33 of the convex rib 34, while extending from the end 31 towards the intermediate portion 16, is firstly sloped radially outwardly from the central axis and then sloped radially inwardly towards the central axis to form a highest portion 35. For example, as illustrated, the head portion 14 may have four channels 32 and four convex ribs 34 in alternating arrangement, and thus be cross-shaped (Phillips head). In other embodiments, the number of grooves 32 and convex ribs 34 may be different such that the head 14 may be in a lenticular, hexagonal, star, square, etc. structure to engage or engage fasteners of a respective different structure. In addition, the head portion of the tool head of the present application is not limited to the illustrated structural form of the channel and convex ribs, and may also be any convex polygonal structure such as triangles, convex tetragons, and convex hexagons.

In the illustrated embodiment, the intermediate portion 16 may be connected to the drive portion 12 by a first transition portion 42 and may be connected to the head portion 14 by a second transition portion 44. The first transition portion 42, the second transition portion 44, and the intermediate portion 16 of the tool head 10 may all have a circular cross-section. The first transition portion 42 extends from the drive portion 12 in a tapered form to the intermediate portion 16, i.e., the first transition portion 42 tapers from an outer diameter at the connection with the drive portion 12 to an outer diameter at the connection with the intermediate portion 16. The first transition portion 42 may have a curvature or outer profile of a concave shape as illustrated, or optionally, may be in a shape of a joint cone. The second transition portion 44 extends from the head portion 14 in tapered form to the intermediate portion 16, i.e., the second transition portion 44 gradually decreases from the outer diameter at the connection with the head portion 14 to the outer diameter at the connection with the intermediate portion 16, and the second transition portion 15 may also have a curvature or outer profile of a concave shape as illustrated, or optionally, may be in a shape of a joint cone.

In the embodiment of FIG. 1, the intermediate portion 16 of the tool head 10 is configured as a tapered portion with an outer profile in the longitudinal section in a straight or linear form, rather than a curvature form, and having a first outer diameter at the connection with the first transition portion 42 and a second outer diameter at the connection with the second transition portion 44. The intermediate portion 16 tapers from the first outer diameter to the second outer diameter at a taper angle a, which can be 0 to 15 degrees, preferably 1 to 4 degrees. The second outer diameter of the intermediate portion 16 has a dimension D, which may be 0.9 mm to 6.1 mm, preferably 1.5 mm to 4 mm. Preferably, the minimum length of the intermediate portion 16 may be approximately 2 mm.

As the outer diameter of the intermediate portion 16 is less than the outer diameter of both ends of the tool head 10 (the drive portion 12 and head portion 14) and the intermediate portion 16 is configured to be tapered, the intermediate portion 16 is capable of better absorbing (a portion of) the rotational torque, for example, by deformation of the intermediate portion 16, to provide a cushioning effect when a rotational torque, such as an impact torque, is applied to the tool head 10 via the driver engaged with the drive portion 12 and before the rotational torque is transmitted via the intermediate portion 16 to the fastener engaged with the head portion 14 of the head tool 10 (thus subjecting the head portion 14 to the counter-torque from the fastener acting on the tool head 10). This substantially reduces the counter-torque to which the tool head 10 (particularly the head portion 14 thereof) is subjected, thus protecting the tool head 10.

The embodiment shown in FIG. 2 is a variant of the embodiment shown in FIG. 1. The tool head 10 in FIG. 2 differs from the tool head 10 in FIG. 1 in that the drive portion 12 does not include the groove 22 and the tool head 10 does not include the first transition portion 42, and thus the intermediate portion 16 is directly connected to the drive portion 12. This structure is typically used in insertable tool heads, which have a smaller overall length of the tool head 10.

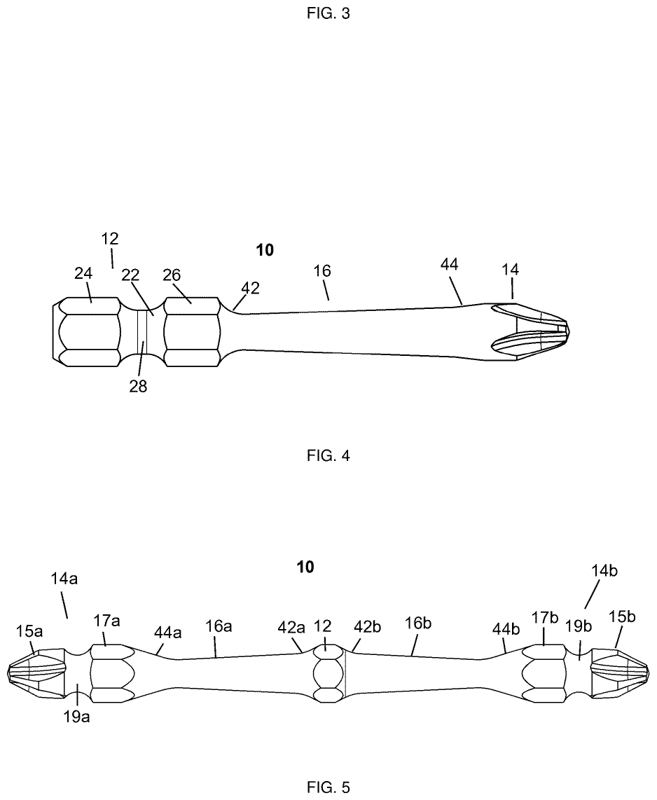

FIG. 3 is another variant of the embodiment shown in FIG. 1. FIG. 3 differs from FIG. 1 in that the intermediate portion 16 is configured as two interconnected tapered portions 52 and 54, optionally connected through a rounded third transition portion 56 having an outer curvature. The two tapered portions 52 and 54 may have the same or different taper parameters, such as the same or different taper degrees, a maximum or minimum outer diameter, or an extension length along the longitudinal direction L. The two tapered portions 52 and 54 may both taper to extend from the drive portion 12 towards the head portion 14 as illustrated, and the maximum outer diameter of the tapered portion 54 may be greater than (as shown in FIG. 3), equal to, or less than the minimum outer diameter of the tapered portion 52. It is conceivable by those skilled in the art that one of the two tapered portions 52 and 54 may taper to extend along a direction from the drive portion 12 towards the head portion 14 while the other may taper to extend along a direction from the head portion 14 towards the drive portion 12. It is also conceivable that the tool head 10 may include two or more tapered portions, with a third transition portion 56 as shown in FIG. 3 optionally provided between adjacent tapered portions, or without any transition portions. In this case, the minimum outer diameter D of the entire intermediate portion 16 (all tapered portions) may be 0.9 mm to 6.1 mm, preferably 1.5 mm to 4 mm, and the minimum length of the intermediate portion 16 may be approximately 2 mm.

In the embodiment shown in FIGS. 1 to 3, the tapered portion that makes up the intermediate portion 16 of the tool head 10 tapers in a direction from the drive portion 12 towards the head portion 14, which is very beneficial to reduce torque impact transmitted to the head portion 14. However, it is understood by those skilled in the art that the present application is not limited to the structure in which the tapered portion of the intermediate portion 16 tapers to extend in this direction. FIG. 4 is yet another variant of the embodiment shown in FIG. 1. In FIG. 4, the head portion 14 has a different structure and the tapered portion of the intermediate portion 16 tapers to extend from a connection with the second transition portion 44 to a connection with the first transition portion 42 in a direction from the head portion 14 towards the drive portion 12. The groove 22 of the drive portion 12 further includes another groove 28 radially recessed from an outer surface of the groove 22. Optionally, the tool head 10 may also not include the second transition portion 44.

A tool head including a head portion is described above with reference to FIGS. 1 to 4. The intermediate portion 16 of the tool head includes at least one tapered portion, for example, may include two or more tapered portions. Optionally, depending on the actual application, the intermediate portion 16 may include: one or more first tapered portions linearly tapering from the drive portion 12 towards the head portion 14, one or more second tapered portions linearly tapering from the head portion 14 towards the drive portion 12, and one or more cylindrical portions, where the one or more first tapered portions, the one or more second tapered portions, and the one or more cylindrical portions may be connected in series in any order in the longitudinal direction L.

FIG. 5 shows an embodiment of a tool head comprising two head portions. In the present embodiment, the tool head 10 includes: a drive portion 12 (in the present embodiment, the drive portion 12 does not include the groove 22 of FIG. 1) adapted to engage a driver, a first intermediate portion 16a protruding along the longitudinal direction L from a first side of the drive portion 12, a first head portion 14a adapted to engage a fastener and connected with the first intermediate portion 16a, a second intermediate portion 16b protruding along the longitudinal direction L from an opposite second side 12b of the drive portion 12, and a second head portion 14b adapted to engage a fastener and connected with the second intermediate portion 16b.

The first intermediate portion 16a and the second intermediate portion 16b have the structure of the intermediate portion 16a of FIG. 1, respectively. The first intermediate portion 16a is connected to the drive portion 12a and the first head portion 14a through the first and second transition portions 42a and 44a, respectively, and the first intermediate portion 16a tapers to extend from a connection with the first transition portion 42a towards a connection with the second transition portion 44a. The second intermediate portion 16b is connected to the drive portion 12b and the second head portion 14b through the third and fourth transition portions 42b and 44b, respectively, and the second intermediate portion 16b tapers to extend from a connection with the third transition portion 42b towards a connection with the fourth transition portion 44b.

In the second embodiment of FIG. 5, the first head portion 14a and the second head portion 14b include engagement tips 15a and 15b, head drive portions 17a and 17b, and recesses 19a and 19b extending in a circumferential direction spacing the tips and the head drive portions in the longitudinal direction L, respectively. This head structure is also applicable to the tool head 10 of FIGS. 1 to 4.

The tool head, the drive portion, and the head portion of the present application are connected by an intermediate portion including a tapered portion, and the longitudinal length of the tapered portion is greater than 50%, preferably greater than 60%, preferably greater than 80%, more preferably greater than 90% of the longitudinal length of the intermediate portion, and most preferably, the longitudinal length of the tapered portion is equal to the longitudinal length of the intermediate portion. When an impact torque is applied the tool head drive portion, the intermediate portion is prone to deformation, which reduces the size of deformation or damaging forces or torque (from the fastener) that the tool head may be subjected to.

During use, a drive source in engagement with the tool head 10 may engage the drive portion 12 of the tool head 10 as illustrated. In this case, it is advantageous for the tapered portions making up the first intermediate portion 16a and the second intermediate portion 16b as illustrated to taper in a direction from the drive portion 12 towards the first head portion 14a and in a direction from the drive portion 12 towards the second head portion 14b, respectively. Optionally, when the tool head 10 is in use, one of the first head portion 14a and the second head portion 14b (i.e., the head drive portion 17a or 17b) may function as a drive portion to engage with a drive source and receive a rotational torque. At this time, the intermediate portion of the head portion for engagement with the drive source can be designed to have a structure that tapers from the head portion towards the other head portion, so that both the first and second intermediate portions taper to extend in the same direction from that head towards the other head, which is more conducive to buffering the impact rotational torque received.

Some particular embodiments of the tool head of the present application are described above with respect to FIGS. 1 to 5, and it should be understood that these embodiments are all exemplary and are not intended to limit the protective scope of the present application. It will also be understood that different features in different embodiments may be recombined with one another to form new embodiments. Accordingly, various modifications, adaptations, and combinations of the features of the described embodiments may be made without departing from the scope of protection defined by the claims.

1. A tool head defining a central axis extending along a longitudinal direction, comprising:
a drive portion configured to engage a driver,
a head portion configured to engage a fastener, and
an intermediate portion connecting the drive portion and the head portion,
wherein the drive portion is connected to the intermediate portion by a first transition portion that tapers to extend from the drive portion in the longitudinal direction to the intermediate portion,
wherein the head portion is connected to the intermediate portion by a second transition portion that tapers to extend from the head portion in the longitudinal direction to the intermediate portion,
wherein the intermediate portion includes a tapered portion having a longitudinal length greater than 80% of the minimum length of the intermediate portion,
wherein, in a longitudinal section of the tool head passing through the central axis, both the first transition portion and the second transition portion have a concave curvature, and
wherein the tapered portion has a linear profile.

2. The tool head according to claim 1, wherein the intermediate portion comprises only one tapered portion that tapers to extend from one of the first transition portion and the second transition portion to the other of the first transition portion and the second transition portion.

3. The tool head according to claim 1, wherein the tapered portion includes one or more tapered portions tapering in a direction from the first transition portion towards the second transition portion; and/or one or more tapered portions tapering in a direction from the second transition portion towards the first transition portion.

4. The tool head according to claim 3, wherein the intermediate portion further comprises a cylindrical portion.

5. The tool head according to claim 1, wherein at least one of the following conditions exists:
the tapered portion has a taper of 1 degree to 4 degrees,
a minimum outer diameter of the intermediate portion is 0.9 mm to 6.1 mm, and
a minimum length of the intermediate portion is 2 mm.

6. The tool head according to claim 1, wherein the drive portion comprises a first drive segment and a second drive segment spaced apart by a groove extending in a circumferential direction about a central axis.

7. The tool head according to claim 1, wherein:
the head portion has a convex polygonal structure, or
the head portion includes two or more convex ribs evenly spaced apart in a circumferential direction around the central axis, and adjacent ribs are spaced apart by a channel.

8. The tool head according to claim 1, wherein:
the intermediate portion and the head portion are a first intermediate portion and a first head portion,
the tool head further includes a second head portion configured to engage a fastener and a second intermediate portion connecting the drive portion and the second head portion, and
the first intermediate portion and the second intermediate portion respectively protrude from opposite sides of the drive portion in the longitudinal direction

9. The tool head according to claim 8, wherein:
the tapered portions that make up the first intermediate portion and the second intermediate portion taper to extend in opposite directions from the drive portion towards the first head portion and the second head portion, respectively, or
the tapered portions that make up the first intermediate portion and the second intermediate portion taper to extend in the same direction from one of the first head portion and the second head portion towards the other of the first head portion and the second head portion.

10. The tool head of claim 9, wherein any one of the first head portion and the second head portion includes:
a head tip configured to engage a fastener,
a head drive portion configured to engage a driver, and
a head groove spacing apart the head tip and the head drive portion in the longitudinal direction.
